(19) United States
(12) Patent Application Publication
(10) Pub. No.: US 2016/0263625 A1
(43) Pub. Date: Sep. 15, 2016

(54) METHOD OF CLEANING MASK COVER AND CLEANING BOARD

(71) Applicant: NuFlare Technology, Inc., Yokohama-shi (JP)

(72) Inventor: Shun KANEZAWA, Yokohama-shi (JP)

(73) Assignee: NuFlare Technology, Inc., Yokohama-shi (JP)

(21) Appl. No.: 15/050,766

(22) Filed: Feb. 23, 2016

(30) Foreign Application Priority Data
Mar. 10, 2015 (JP) 2015-047230

(51) Int. Cl. B08B 1/00; B08B 6/00; B08B 7/00

(52) U.S. Cl. CPC B08B 1/006; B08B 7/0028; B08B 1/007; B08B 6/00

(57) ABSTRACT

In one embodiment, a method of cleaning a mask cover includes loading a cleaning board including a foreign substance removal portion in a surface of the cleaning board into a mask cover housing chamber of a charged particle beam lithography system, the mask cover housing chamber housing a mask cover including: a frame having a central opening; a grounding plate positioned on the frame such that an end of the grounding plate protrudes toward an inner side of the opening, and a grounding pin protruding downward from the end of the grounding plate, positioning the cleaning board below the mask cover, and bringing the mask cover and the cleaning board close to or contact with each other such that the foreign substance removal portion removes a foreign substance attached to the grounding pin.

### CROSS REFERENCE TO RELATED APPLICATION

This application is based upon and claims benefit of priority from the Japanese Patent Application No. 2015-47230, filed on Mar. 10, 2015, the entire contents of which are incorporated herein by reference.

### FIELD

The present invention relates to a method of cleaning mask cover and a cleaning board.

### BACKGROUND

An electron beam lithography system, which is an example of a charged particle beam lithography system, draws a predetermined pattern by irradiating a mask board, in which a glass substrate, a chrome film, and a resist film, for example, are stacked, with electron beams. The mask board is in contact with the ground during the drawing with the electron beams. If the mask board is not in contact with the ground, charge accumulated on the mask board due to the irradiation of the electron beams forms an electric field. The electric field bends the electron beam trajectory, deteriorating lithography accuracy.

To solve the problem, a mask cover including a grounding pin is disposed on the mask board such that the grounding pin penetrates the resist film and comes in contact with the chrome film. The drawing with the electron beams is performed while the chrome film is in contact with the ground.

A foreign substance such as a resist may attach to the front end of the grounding pin when the grounding pin penetrates the resist film, and the foreign substance may drop onto a surface of the mask board. The foreign substance attached to the mask board may cause electron beam drift and a pattern error, deteriorating the lithography accuracy.

Conventionally, the mask cover is taken out from the lithography system and cleaned outside the system such that the foreign substance attached to the grounding pin may be removed. However, in such a method, the down-time of the lithography system is long, adversely affecting productivity.

### BRIEF DESCRIPTION OF THE DRAWINGS

FIG. 1 is a plan view of an electron beam lithography system according to an embodiment of the present invention.

FIG. 2 is a partial cross-sectional view of the electron beam lithography system according to the embodiment.

FIG. 3A is a top view of a mask cover, FIG. 3B is a cross-sectional view of the mask cover H taken along a line III-III in FIG. 3A, and FIG. 3C is a cross-sectional view of a state in which the mask cover is placed on the mask board.

FIGS. 4A and 4B are views for explaining how the mask cover is set on the mask board according to the embodiment.

FIG. 5A is a top view of a cleaning board, and FIG. 5B is a cross-sectional view taken along a line V-V in FIG. 5A.

FIGS. 6A and 6B are views for explaining how a grounding pin is cleaned according to the embodiment.

FIG. 7 is a top view of the cleaning board according to a modification.

### DETAILED DESCRIPTION

In one embodiment, a method of cleaning a mask cover includes loading a cleaning board including a foreign substance removal portion in a surface of the cleaning board into a mask cover housing chamber of a charged particle beam lithography system, the mask cover housing chamber housing a mask cover including: a frame having a central opening; a grounding plate positioned on the frame such that an end of the grounding plate protrudes toward an inner side of the opening, and a grounding pin protruding downward from the end of the grounding plate, positioning the cleaning board below the mask cover, and bringing the mask cover and the cleaning board close to or contact with each other such that the foreign substance removal portion removes a foreign substance attached to the grounding pin.

Hereinafter, an embodiment of the present invention is described with reference to the drawings.

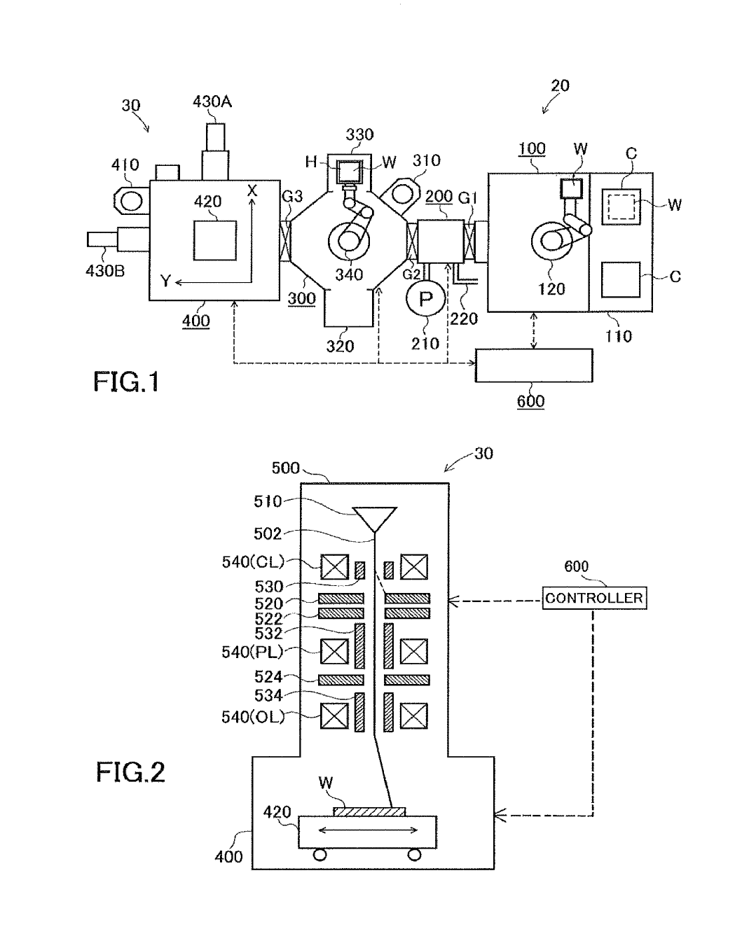

FIG. 1 is a plan view of an electron beam lithography system according to an embodiment of the present invention. FIG. 2 is a cross-sectional view of a writing chamber (W chamber) 400 and an electron beam lens barrel 500, which are parts of the electron beam lithography system. As illustrated in FIG. 1 and FIG. 2, the electron beam lithography system includes an interface (I/F) section 100, a carrying-in-and-out (I/O) chamber 200, a robot chamber (R chamber) 300, the W chamber 400, the electron beam lens barrel 500, a controller 600, and gate valves G1 to G3. In FIG. 1, the electron beam lens barrel 500 is not illustrated. The R chamber 300 constitutes a transfer chamber.

The I/F section 100 includes a mount 110 on which a container C housing a mask board W is placed, and a transfer robot 120 configured to transport the mask board W. The transfer robot 120 also transport a cleaning board 10, which is described later.

The I/O chamber 200 is a “load lock chamber”, which allows the R chamber 300 to remain in a vacuum (low pressure) while the mask board W is carried in and out. The gate valve G1 is disposed between the I/O chamber 200 and the I/F section 100. The I/O chamber 200 includes a vacuum pump 210 and a gas supply system 220. The vacuum pump 210 is a dry pump or a turbomolecular pump, for example, and evacuates the I/O chamber 200. The gas supply system 220 supplies a ventilation gas (a nitrogen gas or CDA, for example) into the I/O chamber 200 such that the pressure in the I/O chamber 200 becomes an atmospheric pressure.

When the I/O chamber 200 needs to be evacuated, a vacuum pump 210 connected to the I/O chamber 200 is used for the evacuation. When the pressure in the I/O chamber 200 needs to be brought back to atmospheric pressure, the ventilation gas is supplied by the gas supply system 220 such that the pressure in the I/O chamber 200 becomes atmospheric pressure. The gate valves G1 and G2 are closed while the I/O chamber 200 is evacuated and the pressure therein is brought back to atmospheric pressure.

The R chamber 300 includes a vacuum pump 310, an alignment chamber 320, a mask cover housing chamber 330, and a transfer robot 340. The R chamber 300 is connected to the I/O chamber 200 through the gate valve G2.

The vacuum pump 310 is a cryopump or a turbomolecular pump, for example. The vacuum pump 310, which is connected to the R chamber 300, evacuates the R chamber 300 so as to maintain a high vacuum in the R chamber 300. The alignment chamber 320 is a chamber for positioning (aligning) the mask board W. The mask cover chamber 330 houses a mask cover H. The mask cover H is described later. The transfer robot 340 transports the mask board W between the I/O chamber 200, the alignment chamber 320, the mask cover housing chamber 330, and the W chamber 400.

The W chamber 400 includes a vacuum pump 410, an X-Y stage 420, and drive units 430A and 430B. The W chamber 400 is connected to the R chamber 300 through the gate valve G3.

The vacuum pump 410 is a cryopump or a turbomolecular pump, for example. The vacuum pump 410, which is connected to the W chamber 400, evacuates the W chamber 400 so as to maintain a high vacuum in the W chamber 400. The X-Y stage 420 is a stage on which the mask board W is placed. The drive unit 430A moves the X-Y stage 420 in an X direction. The drive unit 430B moves the X-Y stage 420 in a Y direction.

As illustrated in FIG. 2, the electron beam lens barrel 500 includes an electron beam irradiator including an electron gun 510, a blanking aperture 520, a first aperture 522, a second aperture 524, a blanking deflector 530, a shaping deflector 532, an objective deflector 534, and lenses 540 (a lighting lens (CL), a projector lens (PL), and an objective lens (OL)). The electron beam lens barrel 500 irradiates the mask board W, which is placed on the X-Y stage 420, with the electron beams. The mask cover H, which is described later, is set on the mask board W to be irradiated with the electron beams. The mask cover H is not illustrated in FIG. 2.

The lighting lens CL allows an electron beam 502 emitted from the electron gun 510, which is an example of a charged particle beam, to illuminate the entire first aperture 522 having a rectangular hole such as a square hole. The electron beam 502 is shaped into a rectangular shape. Then, the projector lens PL allows the electron beam constituting a first aperture image, which has passed through the first aperture 522, to be projected in the second aperture 524. The position of the first aperture image in the second aperture 524 is controlled by the shaping deflector 532, and thus the shape and the dimensions of the beam are varied. Then, the electron beam constituting the second aperture image, which has passed through the second aperture 524, is focused by the objective lens OL and is deflected by the objective deflector 534 so as to be applied to a predetermined position of the mask board W on the X-Y stage 420, which is disposed in a movable manner. The controller 600 controls application of a deflection voltage to the shaping deflector 532 or the objective deflector 534 and movement of the X-Y stage 420, for example. This configuration enables the electron beam lithography system to be a variable-shaped beam lithography system.

In a beam-on state, the blanking deflector 530 allows the electron beam 502 emitted from the electron gun 510 to pass through the blanking aperture 520. In a beam-off state, the blanking deflector 530 deflects the entire beam so as to be blocked by the blanking aperture 520. One electron beam shot is constituted by the electron beam passing through the blanking aperture 520 during the period from immediately after the state is switched from the beam-off state to the beam-on state until the state is switched to the beam-on state again. The intensity of the electron beam applied to the mask board W per shot is adjusted by changing the application duration for one shot.

The controller 600 is a computer, for example, and has functions of controlling the chambers and the gate valves, for example.

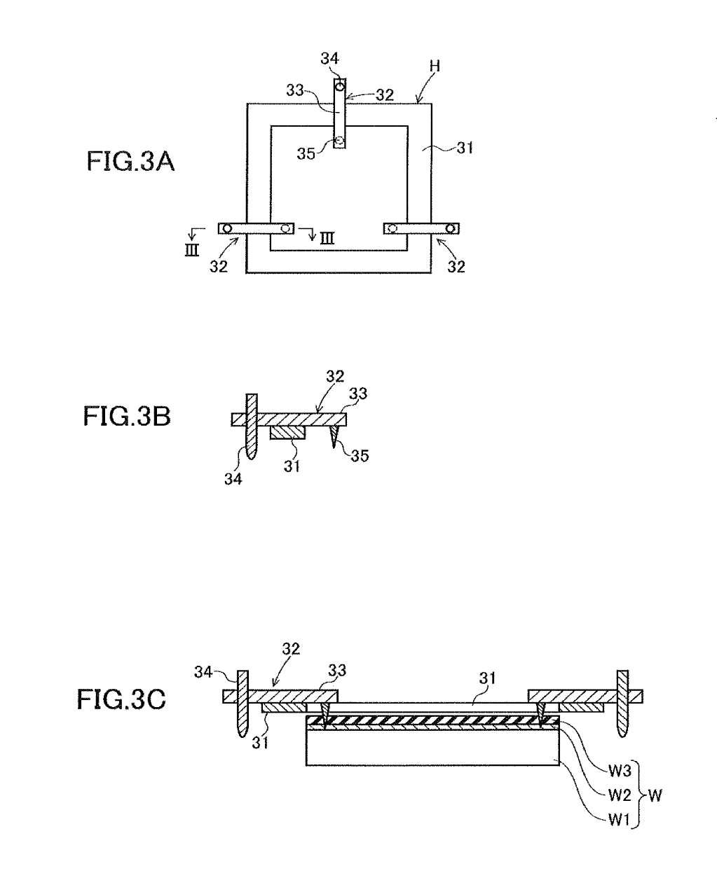

FIG. 3A is a top view of the mask cover H. FIG. 3B is a cross-sectional view of the mask cover H taken along a line III-III in FIG. 3A. FIG. 3C is a cross-sectional view of a state in which the mask cover H is placed on the mask board W.

The mask cover H, which has conductivity, includes a frame 31 having the shape of a picture frame with a central opening and a plurality of grounding units 32 disposed on the frame 31. The frame 31 is slightly larger than the mask board W.

The grounding units 32 each include a grounding plate 33, which is a conductive plate, connected to the frame 31. The grounding plate 33 is positioned such that a first end thereof protrudes toward an outer side of the frame 31 and a second end thereof protrudes toward an inner side of the opening of the frame 31. A support pin 34, which supports the grounding plate 33 and is grounded during the drawing, is disposed on the first end of the grounding plate 33. A grounding pin 35 is disposed on the second end of the grounding plate 33 so as to protrude downward. In FIG. 3A, three grounding units 32 are disposed as an example. The grounding units 32 are disposed on the frame 31 at regular intervals.

The grounding pin 35, which has a conical shape, has a bottom surface having a diameter (width of a portion connected to the grounding plate 33) of about 1 mm.

As illustrated in FIG. 3C, when the mask cover H is set on the mask board W, in which a light blocking film (chrome film, for example) W2 and a resist film W3 are stacked on a glass substrate W1, the grounding pin 35 sticks out through the resist film W3 due to the weight of the mask cover H and comes in contact with the light blocking film W2, which is a conductor.

The drawing using the electron beam is performed on the mask board W on which the mask cover H is placed as described above. In this state, the mask cover H is connected to a ground, which is not illustrated. The charge accumulated on the mask board W due to the irradiation of the electron beam are discharged through the mask cover H.

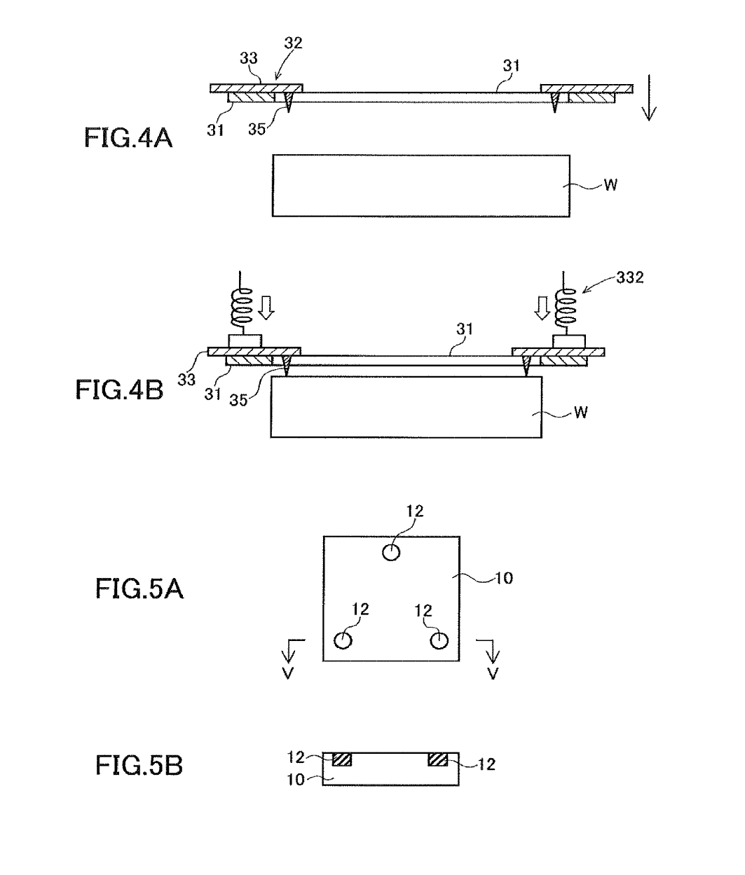

In the mask cover housing chamber 330, the support pin 34 is supported by a vertically movable support unit, which is not illustrated. With this configuration, the mask cover H is supported in a movable manner in vertical directions. The transfer robot 340 transports the mask board W to the mask cover housing chamber 330 and positions the mask board W at a position below the mask cover H. As illustrated in FIG. 4A, the mask cover H is set on the mask board W when the support unit moves down the mask cover H. In FIGS. 4A and 4B, the support pins 34 are not illustrated.

The mask cover housing chamber 330 houses a measuring device, which is not illustrated, for measuring a contact resistance between the mask cover H and the mask board W on which the mask cover H is set. The measuring device includes terminals connected to the grounding pins 35 and a measuring circuit for measuring a current and a voltage between the terminals. The terminals are connected to two grounding pins 35, and a current value and a voltage value between the terminals are measured to determine whether the grounding pins 35 and the light blocking film W2 are connected and grounded.

As illustrated FIG. 4B, the mask cover housing chamber 330 houses a pressing unit 332 for pressing the mask cover H down against the mask board W. The pressing unit 332 includes an elastic member such as a spring such that the mask cover H is pressed down softly. The pressing force applied to the mask cover H by the pressing unit 332 is adjustable. The pressing unit 332 presses the mask board W during the measurement of the contact resistance by the measuring device, which is described above.

A foreign substance (a contamination or a particle) is generated when the grounding pin 35 sticks out through the resistant film W3 during the setting of the mask cover H on the mask board W and becomes attached to the front end of the grounding pin 35. The foreign substance dropped on the mask board W may cause electron beam drift or a pattern error, for example, deteriorating the lithography accuracy. Thus, the cleaning of the grounding pins 35 is required to remove the foreign substance attached to the front end.

In this embodiment, the cleaning board 10 as illustrated in FIG. 5 is used to clean the grounding pins 35. FIG. 5A is a top view of the cleaning board 10. FIG. 5B is a cross-sectional view taken along a line V-V in FIG. 5A.

The cleaning board 10 has a shape, size, and thickness substantially identical to those of the mask board W so as to be transported by the transfer robots 120 and 340 as the mask board W.

The cleaning board 10 includes adhesive resin layers 12 as foreign substance removal portions in a surface of the cleaning board 10 at positions corresponding to the grounding pins 35 of the mask cover H. Three adhesive resin layers 12 are disposed, for example, so as to correspond to the three grounding pins 35 illustrated in FIG. 3A.

The cleaning board 10 is formed of a glass substrate or a metal substrate such as an aluminum substrate, for example. The adhesive resin layers 12 are formed of a butyl rubber or a urethane rubber, for example.

The adhesive resin layer 12 may have any thickness larger than the length (height) of a section of the grounding pin 35 to which the foreign substance is attached. In FIG. 5A, the adhesive resin layer 12 is circular in plan view, but may be elliptical, or rectangular. The adhesive resin layer 12 may have any size (width dimension) larger than the diameter of the grounding pin 35.

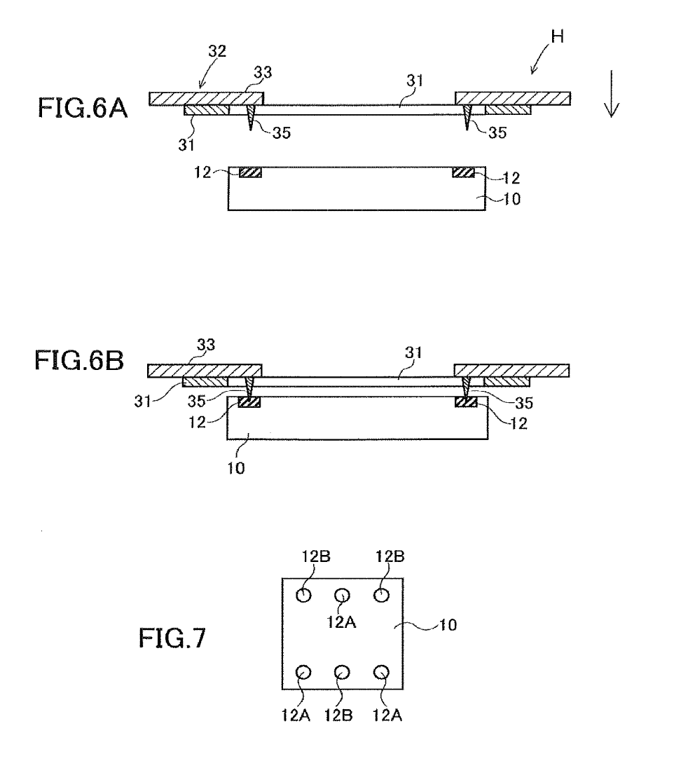

The cleaning board 10 is carried into the mask cover housing chamber 330 through the I/F section 100 and the I/O chamber 200 such that the adhesive resin layers 12 are positioned below the grounding pins 35. Then, as illustrated in FIG. 6A, the support unit is activated to move down the mask cover H. As illustrated in FIG. 6B, the adhesive resin layers 12 and the front ends of the grounding pins 35 come in contact with each other, and the foreign substances attached to the front ends of the grounding pins 35 are removed by the adhesive resin layers 12. The grounding pins 35 are cleaned in this manner.

Then, the mask cover H is moved up such that the mask cover H separates from the cleaning board 10. The foreign substances remain attached to the adhesive resin layers 12. Then, the cleaning board 10 is carried out of the mask cover housing chamber 330 and taken out from the lithography system through the I/O chamber 200 and the I/F section 100.

The cleaning board 10 taken out from the lithography system is reused after removal of the foreign substances attached to the adhesive resin layers 12 or after replacement of the adhesive resin layers 12 with new adhesive resin layers. An adhesive resin formed of the same material as the adhesive resin layers 12 is brought into contact with the adhesive resin layers 12, to which the foreign substances are attached, for example, to remove the foreign substances from the adhesive resin layers 12.

After the adhesive resin layers 12 come in contact with the grounding pins 35, the mask cover H may be pressed down softly by using the pressing unit 332. The mask cover H may be pressed once or a plurality of times. This accelerates the removal of the foreign substances from the grounding pins 35.

The mask cover H may be moved up and down repeatedly such that the adhesive resin layers 12 and the grounding pins 35 come in contact with each other repeatedly. This accelerates the removal of the foreign substances from the grounding pins 35. The cleaning board 10 may be moved up and down repeatedly.

The removal of the foreign substances from the grounding pins 35 prevents the deterioration of the lithography accuracy caused by the foreign substances dropped on the surface of the mask board W. In addition, since the foreign substances removed from the grounding pins 35 are attached to the adhesive resin layers 12, the removed foreign substances do not drop during the transport of the cleaning board 10, preventing the inside of the chamber in the lithography system from being contaminated.

As described above, the time required for cleaning the grounding pins 35 is shortened by the steps of carrying the cleaning board 10 into the mask cover housing chamber 330, bringing the adhesive resin layers 12 to be in contact with the grounding pins 35, and carrying the cleaning board 10 out of the mask cover housing chamber 330. Compared to a method in which the mask cover H is taken out and cleaned outside the system, the down time of the lithography system is short, reducing the deterioration in the productivity.

The number of the adhesive resin layers 12 in the surface of the cleaning board 10 may be larger than the number of the grounding pins 35. As illustrated in FIG. 7, the numbers of the adhesive resin layers may be six (three adhesive resin layers 12A and three adhesive resin layers 12B), for example. The adhesive resin layers 12A and the adhesive resin layers 12B are symmetrically arranged.

The grounding pins 35 are cleaned by using the adhesive resin layers 12A, and then the cleaning board 10 is taken out from the lithography system, for example. The cleaning board 10 is turned 180 degrees and carried into the lithography system for the next cleaning in which the adhesive resin layers 12B are used to clean the grounding pins 35. Three adhesive resin layers may be disposed along each of four sides of the cleaning board 10 having a substantially square shape, i.e., a total of twelve adhesive resin layers may be disposed, for example. In this case, the cleaning board 10 taken out from the lithography system is horizontally turned 90 degrees or 270 degrees and then carried into the lithography system.

This enables one cleaning board 10 to be used repeatedly for the cleaning of the grounding pins 35 without requiring replacement of the adhesive resin layers 12, for example.

The R chamber 300 is in the vacuum (low pressure) state during the cleaning of the grounding pins 35, and thus gas may be generated by the adhesive resin layers 12. The size of the adhesive resin layer 12 is preferably small and the number of the adhesive resin layers 12 is preferably small to reduce the amount of gas to be generated.

A camera may be disposed at an upper section of the I/O chamber 200 such that surfaces of the adhesive resin layers 12 after the cleaning of the grounding pins 35 may be observed. If the observation reveals that the amount of the foreign substances attached to the adhesive resin layers 12 is small, the number of up-down movements of the mask cover H, the pressing force applied to the mask cover H by the pressing unit 332, or the number of pressing actions may be adjusted. This enables effective cleaning of the grounding pins 35.

In the above-described embodiment, the foreign substances are removed from the grounding pins 35 by using the adhesive resin layers 12 disposed in the cleaning board 10. However, materials other than the adhesive resin may be used for the foreign substance removal portion. The adhesive resin layers 12 may be replaced with a wiping cloth, for example. The wiping cloth may be formed of a non-woven cloth including a nylon fiber or polyester fiber. When the cleaning board 10 including the wiping cloth is used, the moving up and down of the mask cover H is preferably repeated or the pressing of the mask cover H by using the pressing unit 322 is preferably repeated to remove the foreign substances from the grounding pins 35.

The adhesive resin layers 12 of the cleaning board 10 may be replaced with electrodes configured to cause static electricity such that the foreign substances on the grounding pins 35 are attracted by the static electricity. In such a case, the cleaning board 10 includes a power supply (battery) and a static electricity generation circuit. During the cleaning of the grounding pins 35, the grounding pins 35 are moved close to the electrodes so as not to come in contact with the electrodes 10 of the cleaning board 10.

In the above-described embodiment, the electron beam is used, but the present invention is not limited to this, and other charged particle beams such as an ion beam may be used.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of cleaning a mask cover, comprising:
loading a cleaning board including a foreign substance removal portion in a surface of the cleaning board into a mask cover housing chamber of a charged particle beam lithography system, the mask cover housing chamber housing a mask cover including: a frame having a central opening; a grounding plate positioned on the frame such that an end of the grounding plate protrudes toward an inner side of the opening, and a grounding pin protruding downward from the end of the grounding plate;
positioning the cleaning board below the mask cover; and
bringing the mask cover and the cleaning board close to or contact with each other such that the foreign substance removal portion removes a foreign substance attached to the grounding pin.

2. The method according to claim 1, wherein the foreign substance removal portion is disposed at a position corresponding to the grounding pin.

3. The method according to claim 1, wherein the foreign substance removal portion is an adhesive resin layer, and the adhesive resin layer and a front end of the grounding pin are brought into contact with each other so as to remove the foreign substance attached to the grounding pin.

4. The method according to claim 3, comprising pressing the mask cover down while the adhesive resin layer and the front end of the grounding pin are in contact with each other.

5. The method according to claim 4, comprising observing a surface of the adhesive resin layer with a camera after cleaning of the grounding pin and adjusting a pressing force applied to the mask cover in accordance with a result of the observation.

6. The method according to claim 3, comprising moving the mask cover or the cleaning board up and down repeatedly to allow the adhesive resin layer and the grounding pin to come in contact with each other repeatedly.

7. The method according to claim 3, comprising bringing an adhesive resin formed of a material identical to a material of the adhesive resin layer into contact with the adhesive resin layer after cleaning of the grounding pin such that the foreign substance is removed from the adhesive resin layer.

8. The method according to claim 7, wherein the adhesive resin layer includes a butyl rubber or a urethane rubber.

9. The method according to claim 1, wherein the number of the foreign substance removal portions in the cleaning board is larger than the number of the grounding pins, and
the method comprises rotating the cleaning board horizontally and positioning the cleaning board below the mask cover such that the grounding pin is cleaned with another foreign substance removal portion that is different from one used in previous cleaning.

10. The method according to claim 1, wherein the foreign substance removal portion is a wiping cloth, and
the method comprises bringing the wiping cloth and a front end of the grounding pin in contact with each other such that the foreign substance attached to the grounding pin is removed.

11. The method according to claim 1, wherein the cleaning board includes a power supply and a static electricity generation circuit, and the foreign substance removal portion is an electrode configured to cause static electricity, and the method comprises moving a front end of the grounding pin close to the electrode such that the foreign substance attached to the grounding pin is removed.

12. A cleaning board for removing a foreign substance attached to a grounding pin in a mask cover housing chamber of a charged particle beam lithography system, the mask cover housing chamber housing a mask cover including: a frame having a central opening; a grounding plate positioned on the frame such that an end of the grounding plate protrudes toward an inner side of the opening, and a grounding pin protruding downward from the end of the grounding plate, wherein
a foreign substance removal portion is disposed at a position corresponding to the grounding pin.

13. The cleaning board according to claim 12, wherein the foreign substance removal portion is an adhesive resin layer.

14. The cleaning board according to claim 12, wherein the foreign substance removal portion is a wiping cloth.

15. The cleaning board according to claim 12, wherein the cleaning board includes a power supply and a static electricity generation circuit, and the foreign substance removal portion is an electrode configured to cause static electricity.
